(19) United States
(12) Patent Application Publication
(10) Pub. No.: US 2020/0232490 A1
(43) Pub. Date: Jul. 23, 2020

(54) CLIP

(71) Applicant: Maruso Industry Co., Ltd., Fukuoka (JP)

(72) Inventors: Osamu YAMADA, Fukuoka (JP); Eiji SHIMIZU, Fukuoka (JP)

(21) Appl. No.: 16/844,720

(22) Filed: Apr. 9, 2020

Related U.S. Application Data
(63) Continuation-in-part of application No. 15/902,445, filed on Feb. 22, 2018.

(30) Foreign Application Priority Data
Feb. 28, 2017 (JP) 2017-037235

(51) Int. Cl. F16B 2/22; F16B 2/10; D06F 55/00

(52) U.S. Cl. CPC F16B 2/22; D06F 55/00; F16B 2/10

(57) ABSTRACT

A clip includes a first body and a second body, the first body including a first part, a second part, and a first hinge through which the first and second parts are joined, the second body including a movable portion and a second hinge, the movable portion being joined at one end thereof to the first part through the second hinge so as to be swingable in a plane defined by the first and second parts, a part of the first body and a part of the second body defining a lock for locking the movable portion to the second part, the movable portion having such a shape that there is formed a space between the first body and the movable portion when the movable portion and the second part are locked to each other through the lock, the first and second bodies being integrally formed of an elastic material.

This application is a continuation-in-part (CIP) application based on the patent application Ser. No. 15/902,445 filed on Feb. 22, 2018, and further is based upon and claims the benefit of priority from Japanese Patent Application No. 2017-037235 filed on Feb. 28, 2017, the entire disclosure of which, including specification, claims, drawings and summary, is incorporated herein by reference in its entirety.

### BACKGROUND OF THE INVENTION

### Field of the Invention

The invention relates to a clip used for releasably pinching a portion of a folded cloth, a portion of a cloth hanging on a hanger, and so on, and releasably bundling straps such as electric cords.

### Description of the Related Art

A clip is used for pinching a portion of a folded cloth, a portion of a cloth hanging on a hanger, and so on. There have been suggested a lot of clips having various shapes and functions. For instance, Japanese Patent Application Publication No. 2008-113890 has suggested a clip.

FIG. 1 is a perspective view of the clip suggested in the Publication.

As illustrated in FIG. 1, the clip includes a first body 101 and a second body 102.

The first body 101 includes a first part 111, a second part 112, and a connector through which an end of the first part 111 and an end of the second part 112 are joined to each other. The first body 101 is almost U-shaped.

A pair of holders 115 is formed on an outer surface of the first part 111. The holders 115 are spaced away from each other in a width-wise direction of the first part 111. Each of the holders 115 extends from an outer surface of the first part 111. Each of the holders 115 is formed with a through-hole 114.

A projection 116 having a semicircular top is formed on an outer surface of the second part 112.

The second body 102 is almost C-shaped, and is formed at both surfaces thereof with projections 121. By fitting the projections 121 into the through-holes 114 formed through the holders 115, the second body 102 is joined to the first body 101 such that the second body 102 is swingable relative to the first body 101 around the projections 121.

The second body 102 is formed with a recess 122 in the vicinity of the other end. The projection 116 of the first body 101 is fittable into the recess 122.

A circular portion 123 extends outwardly from an outer surface of the second body 102 almost at the center of the second body 102. The circular portion 123 is formed with a through-hole 124.

The first and second bodies 101 and 102 are made of a synthetic resin such as polycarbonate.

FIG. 2 is a perspective view showing that the second body 102 is engaged to the first body 101.

As illustrated in FIG. 2, by swinging the second body 102 around the projections 121 or the through-holes 114 in a clock-wise direction relative to the first body 101, and then, causing the projections 116 to fit into the recess 122, the first and second parts 111 and 112 of the first body 101 can be kept closed to each other. Thus, it is possible to pinch a target between a distal end 117 of the first part 111 and an inner surface of the second part 112.

The clip illustrated in FIGS. 1 and 2 has advantages that it is possible to prevent the first and second parts 111 and 112 from unintentionally being released from each other, even if the clip is oscillated while pinching a portion of a target, and the first and second parts 111 and 112 can be readily released from each other.

However, the conventional clip illustrated in FIGS. 1 and 2 is accompanied with the following problems.

Firstly, since the conventional clip is comprised of two parts, that is, the first and second bodies 101 and 102, these two parts have to be fabricated independently of each other, causing it difficult to simplify a fabrication process.

Secondly, since these two parts have to be assembled to the clip, that is, since an assembly step has to be carried out, it is difficult to simplify a fabrication process.

Thirdly, if a clip is relatively large in size, it would be possible to accomplish a structure in which the projections 121 of the second body 102 are fit into the through-holes 114 of the first body 101. However, if a clip is to be downsized, it will be very difficult to accomplish the structure.

Fourthly, it is not always easy to fit the projection 166 of the first body 101 into the recess 122 of the second body 102.

In order to cause the projection 116 to be fit into the recess 122, it is necessary to lift up the recess 122 beyond the projection 116. Similarly, it is necessary to lift up the recess 122 beyond the projection 116 in order to release the recess 122 from the projection 116.

That is, it was not so easy to fit the projection 116 into the recess 122, and release the recess 122 from the projection 116.

Fifthly, it is necessary to fabricate the first and second bodies 101 and 102 with an extremely low tolerance.

As illustrated in FIG. 2, when the first and second bodies 101 and 102 are joined to each other, an inner surface of the second body 102 and an outer surface of the first body 101 make close contact with each other. Accordingly, the first and second bodies 101 and 102 have to be fabricated such that a configuration at an inner surface of the second body 102 is coincident with a configuration at an outer surface of the first body 101.

For instance, if a configuration at an outer surface of the first body 101 were fabricated to outwardly project to a higher degree than designed, the first and second bodies 101 and 102 could not make close contact with each other, and thus, it would be impossible for the projection 116 to fit into the recess 122.

Thus, it is necessary to fabricate both a configuration at an inner surface of the second body 102 and a configuration at an outer surface of the first body 101 with high accuracy.

### SUMMARY OF THE INVENTION

In view of the above-mentioned problems in the conventional clip, it is an object of the present invention to provide a clip capable of solving the problems accompanied with the conventional clip.

The present invention provides a clip (200) including a first body (23A) and a second body (23B), the first body (23A) and the second body (23B) being integrally made of an elastic material, the first body (23A) including a first part (21), a second part (22), and a first hinge (20) through which one (21a) of ends of the first part (21) and one (22a) of ends of the second part (22) are joined to each other such that the other end (21b) of the first part (21) and the other end (22b) of the second part (22) can move towards and away from each other, guides (21e, 22e) being formed at the other end (21b) of the first part (21) and the other end (22b) of the second part (22), respectively, the guides (21e, 22e) projecting more inwardly than the other ends (21b, 22b), the second body (23B) including a movable portion (25) having a shape crossing over the first and second parts (21, 22) around the first hinge (20), and a second hinge (24), the movable portion (25) being joined at one of ends thereof to the first part (21) through the second hinge (24) so as to be swingable in a plane defined by the first and second parts (21, 22), a part of the first body (23A) and a part of the second body (23B) defining a lock (28) for detachably locking the other end of the movable portion (25) to the second part (22), the lock (28) including an arcuate portion (27) formed at the other end of the movable portion (25), and a recess (26) formed at an outer surface of the second part (22), the arcuate portion (27) being fittable into the recess (26), wherein the first hinge (20) works as a fulcrum (F2), the guides (21e, 22e) work as points of action (F3), and both the second hinge (24) and the arcuate portion (27) work as power points (F1) while the clip (200) is pinching an object (600), the power points (F1) being located between the fulcrum (F2) and the points of action (F3).

It is preferable that the movable portion (25) is C-shaped.

It is preferable that the second part (12) includes a flat guiding surface (12d) at an outer surface, the flat guiding surface (12d) leading to the recess (16), the flat guiding surface (12d) inclining relative to a length-wise direction of the second part (12), the arcuate portion (17) sliding on the flat guiding surface (12d), and then, being fit into the recess (16).

It is preferable that the arcuate portion (17) defines a part of a circle, and a center (17A) of the circle is situated closer to an outer surface of the second part (12) than an extension (12dA) of the flat guiding surface (12d) when the arcuate portion (17) is fit into the recess (16).

It is preferable that the first part (11) includes an extension (19) outwardly extending from an outer surface of the first part (11) between the other end (11b) of the first part (11) and the second hinge (14).

It is preferable that the first and second parts (11, 12) include at least one projection (11f-11g, 12f-12g) projecting from an inner surface of the first and second parts (11, 12) towards the second and first part (12, 11), the projections (11f-11g, 12f-12g) of the first and second parts (11, 12) partially making contact with each other or partially overlapping each other when the other ends (11b, 12b) of the first and second parts (11, 12) move towards each other.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a perspective view of the conventional clip.

FIG. 2 is a perspective view of the conventional clip.

FIG. 3 is a perspective view of the clip in accordance with the first embodiment of the present invention.

FIG. 4 is a plan view of the clip illustrated in FIG. 3, as viewed in a direction indicated with an arrow “A” shown in FIG. 3.

FIG. 5 is a plan view of the clip illustrated in FIG. 3 in an open condition.

FIG. 6 is a plan view of the clip illustrated in FIG. 3 in a closed condition.

FIG. 7 is a partial plan view of the clip illustrated in FIG. 3.

FIG. 8 is a perspective view of the clip in accordance with the second embodiment of the present invention.

FIG. 9 is a plan view of the clip illustrated in FIG. 8, as viewed in a direction indicated with an arrow “B” shown in FIG. 8.

FIG. 10 is a plan view of the clip illustrated in FIG. 8 in an open condition.

FIG. 11 is a plan view of the clip illustrated in FIG. 8 in a closed condition.

FIG. 12 is a perspective view of the clip in accordance with the third embodiment of the present invention.

FIG. 13 is a plan view of the clip illustrated in FIG. 12, as viewed in a direction indicated with an arrow “C” shown in FIG. 12.

FIG. 14 is a plan view of the clip illustrated in FIG. 12 in an open condition.

FIG. 15 is a plan view of the clip illustrated in FIG. 12 in a closed condition.

FIG. 16 is a perspective view of the clip in accordance with the fourth embodiment of the present invention.

FIG. 17 is a plan view of the clip illustrated in FIG. 16, as viewed in a direction indicated with an arrow “D” shown in FIG. 16.

FIG. 18 is a plan view of the clip illustrated in FIG. 16 in an open condition.

FIG. 19 is a plan view of the clip illustrated in FIG. 16 in a closed condition.

FIG. 20 is a cross-sectional view taken along the line S-S shown in FIG. 18.

FIG. 21 is a cross-sectional view taken along the line T-T shown in FIG. 18.

FIG. 22 is a plan view of the clip in accordance with the second embodiment of the present invention.

FIG. 23 is a plan view of the clip disclosed in U.S. Pat. No. 7,360,286.

FIG. 24 is a plan view of the clip in accordance with the second embodiment of the present invention.

FIG. 25 is a plan view of the clip in use, disclosed in U.S. Pat. No. 7,360,286.

FIG. 26 is a plan view of the clip in use, in accordance with the second embodiment of the present invention.

### DESCRIPTION OF THE EXEMPLARY EMBODIMENTS

Exemplary embodiments in accordance with the present invention will be explained hereinbelow with reference to drawings.

### (First Embodiment)

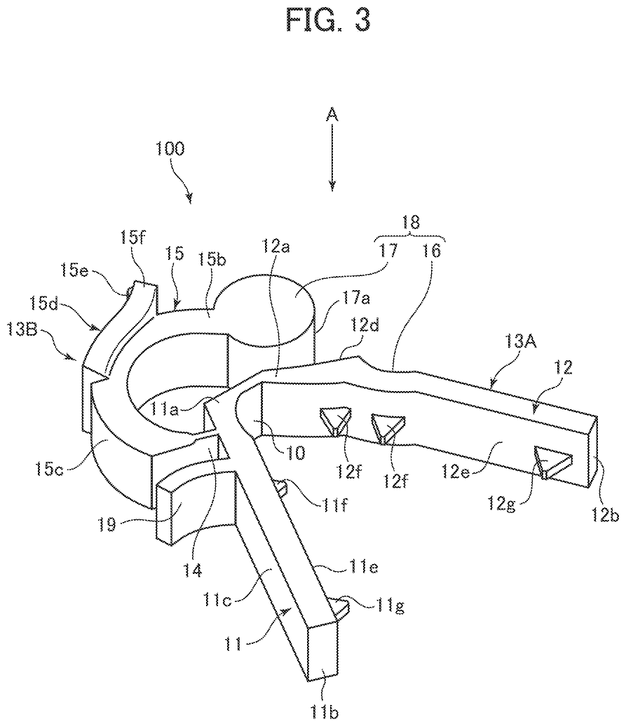

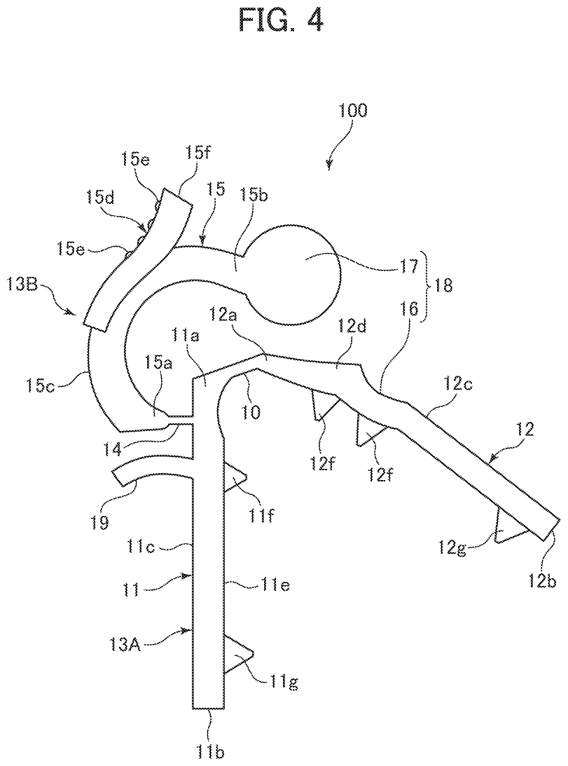

FIG. 3 is a perspective view of a clip 100 in accordance with the first embodiment of the present invention, and FIGS. 4 to 6 are plan views of the clip 100.

As illustrated in FIG. 3, the clip 100 is comprised of a first body 13A and a second body 13B. The first and second bodies 13A and 13B are integrally formed with each other, and made of an elastic material.

The first body 13A includes a first part 11 having a rectangular cross-section and being in the form of a plate, a second part 12 having a rectangular cross-section and being in the form of a plate, and a first hinge 10.

The first hinge 10 is in the form of a flat plate and is designed to have a thickness smaller than the same of the first and second parts 11 and 12. While an external force does not act on the clip 100, as illustrated in FIG. 3, the clip 100 is almost V-shaped. Since the clip 100 is made of an elastic material, the first hinge 100 can elastically deform. Accordingly, the first and second part 11 and 12 are able to swing about the first hinge 10, and thus, an end 11b of the first part 11 and an end 12b of the second part 12 can move towards and away from each other.

The first part 11 includes an extension 19 outwardly extending from an outer surface 11c of the first part 11 between the other end 11b of the first part 11 and a later-mentioned second hinge 14.

The extension 19 is in the form of a plate slightly bending so as to protrude towards an end 11a of the first part 11.

The first part 11 is formed on an inner surface 11e thereof with two triangular projections 11f and 11g spaced away from each other in a length-wise direction of the first part 11. The projections 11f and 11g project towards the second part 12. The projection 11f is located in the vicinity of the end 11a of the first part 11, and the projection 11g is located in the vicinity of the other end 11b of the first part 11.

The second part 12 is formed on an inner surface 12e thereof with three triangular projections 12f and 12g spaced away from each other in a length-wise direction of the second part 12. The projections 12f and 12g project towards the first part 11. The two projections 12f are located in the vicinity of the end 12a of the second part 12, and the projection 12g is located in the vicinity of the other end 12b of the second part 12.

As mentioned later, when the first and second parts 11 and 12 are closed towards each other, the projection 11f of the first part 11 are located between the two projections 12f of the second part 12, and the projection 11g of the first part 11 and the projection 12g of the second part 12 come to be adjacent to each other.

The second body 13B includes a second hinge 14, and a movable portion 15 having a shape across the first part 11 to the second part 12 around the first hinge 10.

As illustrated in FIG. 3, the movable portion 15 is C-shaped, and is joined at one end thereof to an outer surface 11c of the first part 11 through the second hinge 14.

The second hinge 14 is located closer to the first hinge 10 or the end 11a of the first part 11 than a center of the first part 11 in a length-wise direction of the first part 11.

The second hinge 14 is in the form of a planar plate, and is designed to have a thickness smaller than the same of the second part 12. Since the second hinge 14 is made of an elastic material, the second hinge 14 can be elastically deformed. Accordingly, the movable portion 15 is able to swing relative to the first body 13A in a plane defined by the first and second parts 11 and 12 (a plane defined by FIG. 3).

As mentioned later, a part of the first body 13A and a part of the second body 13B define a lock 18 by which the other end of the movable portion 15 and the second part 12 can be detachably locked.

The movable portion 15 is designed to have at the other end 15b thereof an engagement portion 17 being in the form of a pillar.

The second part 12 is formed at an outer surface 12c thereof with a recess 16 into which an arcuate portion 17a, which is a portion of the engagement portion 17, can be fit.

The recess 16 of the first body 13A and the engagement portion 17 of the second body 13B define the lock 18 for detachably locking the first body 13A and the second body 13B to each other.

The second part 12 is formed at the outer surface 12c thereof with a flat guiding surface 12d leading to the recess 16. The guiding surface 12d inclines relative to a length-wise direction of the second part 12. As mentioned later, the engagement portion 17 slides on the guiding surface 12d, and then, is fit into the recess 16.

A finger-contact portion 15d is formed integrally with the movable portion 15 on an outer surface 15c of the movable portion 15. The finger-contact portion 15d arcuately extends towards a distal end 15b of the movable portion 15. The finger-contact portion 15d is formed at a surface thereof with a plurality of nonskid projections 15e.

The clip 100 having the above-mentioned structure is used as follows. The following is just an example, and how to use the clip 100 is not to be limited to the following.

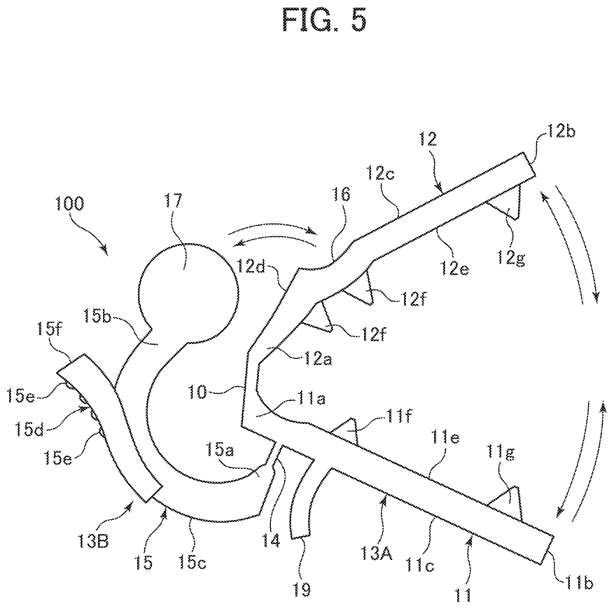

As illustrated in FIG. 5, the first and second parts 11 and 12 can elastically move towards and away from each other around the first hinge 10, and the movable portion 15 is elastically swingable around the second hinge 14. While an external force does not act on the clip 100, the other end 11b of the first part 11 and the other end 12b of the second part 12 are spaced away from each other, and the engagement portion 17 formed at the distal end 15b of the movable portion 15 is away from the recess 16 formed at the outer surface 12c of the second part 12.

When a user intends to use the clip 100, he/she puts his/her thumb onto the extension 19, and his/her index finger onto the finger-contact portion 15d to thereby entirely hold the clip 100.

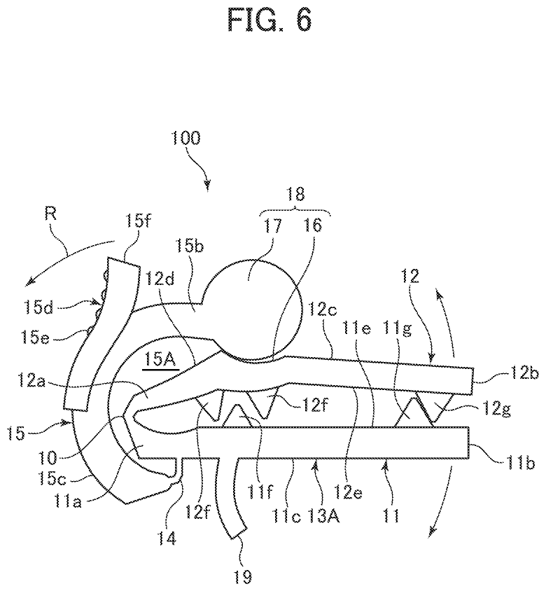

After a target (not illustrated) is pinched between the first and second parts 11 and 12, the user applies a force to his/her thumb and index finger to thereby cause the other ends 11b and 12b of the first and second parts 11 and 12 to move towards each other. Then, the engagement portion 17 makes contact with the guiding surface 12d, and then, slides on the guiding surface 12d towards the recess 16. Thereafter, the engagement portion 17 is fit into the recess 16. Thus, as illustrated in FIG. 6, the first and second parts 11 and 12 are locked to thereby be kept closed to each other, rendering a target (not illustrated) to be pinched between the first and second parts 11 and 12.

After the engagement portion 17 has been fit into the recess 16, even if the user releases his/her thumb and index finger from the clip 100, the engagement portion 17 is kept fit in the recess 16, ensuring that a target can be stably held by the clip 100.

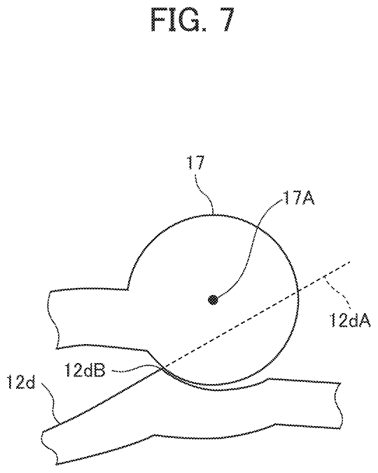

FIG. 7 is a partially enlarged view of the engagement portion 17 and the recess 16, showing a positional relation between them.

When the engagement portion 17 is fit into the recess 16, a center 17A of the circular engagement portion 17 is situated below an extension line 12dA extending from the guiding surface 12d. That is, the center 17A is situated closer to the outer surface 12c of the second part 12 than the extension line 12dA. Thus, even if the engagement portion 17 attempts to return to its original position (the position illustrated in FIG. 3) because of the elastic restoring force caused by the movable portion 15, the engagement portion 17 makes abutment with a corner 12dB of the guiding surface 12d, thus preventing the engagement portion 17 from returning to its original position. Thus, the engagement portion 17 is kept fit in the recess 16.

While the clip 100 is in such a condition as illustrated in FIG. 6, the triangular projections 11f, 11g, 12f and 12g eat into a target pinched between the first and second parts 11 and 12, and accordingly, the target cannot be readily released out of the clip 100, even if an external force acts on the target.

When the user intends to release a target out of the clip 100, he/she makes contact at his/her finger with a distal end 15f of the finger-contact portion 15, and applies a force in a direction indicated with an arrow “R”. Thus, the engagement portion 17 is released from the recess 16, and then, the movable portion 15, the first part 11 and the second part 12 are returned to an open position illustrated in FIG. 5 due to the elastic restoring force thereof. Thus, the target can be readily released out of the clip 100.

The clip 100 in accordance with the first embodiment provides the following advantages.

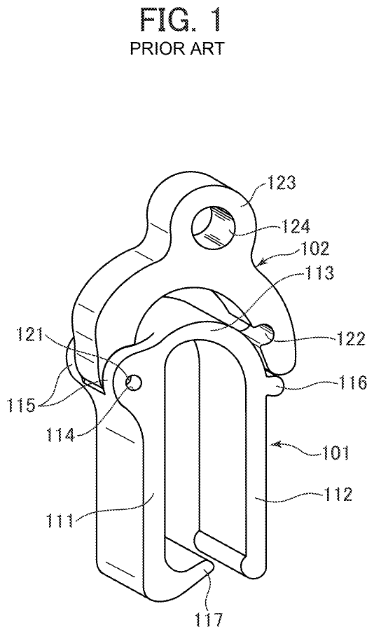

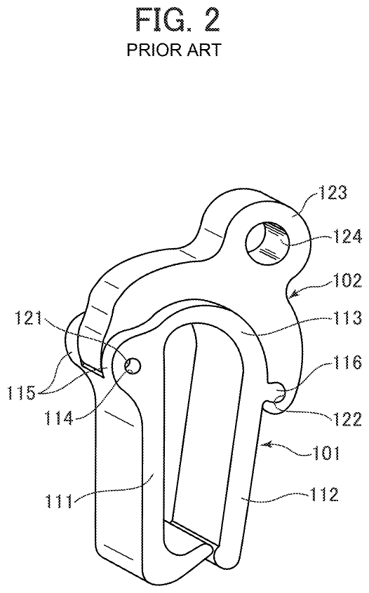

Firstly, the clip 100 in accordance with the first embodiment is a single-piece product where the first body 13A and the second body 13B are formed integral with each other. Accordingly, unlike the conventional clip illustrated in FIGS. 1 and 2, it is no longer necessary to fabricate the two parts (the first body 13A and the second body 13B) independently of each other, ensuring it possible to simplify a process of fabricating the clip 100.

Secondly, since the clip 100 is a single-piece product, it is no longer necessary to assemble two parts into a final product, ensuring it possible to further simplify a process of fabricating the clip 100.

In particular, a time-consuming and burdensome step of fitting the projection 121 of the second body 102 into the through-hole 114 of the first body 101 is no longer necessary to be carried out, ensuring that a time for fabrication can be shortened, and a fabrication process can be simplified.

Thirdly, whereas it was difficult to downsize the conventional clip, the clip 100 in accordance with the first embodiment can be readily downsized. That is, the clip 100 in accordance with the first embodiment can be designed to be of any size.

Fourthly, in the conventional clip, it was necessary to lift up the recess 122 beyond the projection 116 in order to cause the projection 116 to be fit into the recess 122 or to release the recess 122 from the projection 116.

In contrast, in the clip 100 in accordance with the first embodiment, it is possible to cause the engagement portion 17 to be fit into the recess 16 merely by sliding the engagement portion 17 on the guiding surface 12d, and further, it is possible to release the engagement portion 17 out of the recess 16 merely by pushing the engagement portion 17. The first and second bodies 13A and 13B can be joined to and released from each other more readily than the conventional clip.

Fifthly, it was necessary in the conventional clip to fabricate the first and second bodies 101 and 102 with an extremely low tolerance.

In contrast, it is not necessary in the clip 100 in accordance with the first embodiment to fabricate the first and second bodies 13A and 13B with a low tolerance.

As illustrated in FIG. 6, the movable portion 15 is designed to have such a shape that there is formed a space 15A between the first body 13A and the movable portion when the engagement portion 17 is locked into the recess 16. That is, the clip 100 in accordance with the first embodiment is structurally different from the conventional clip in that the first and second bodies 13A and 13B do not make close contact with each other when the first and second bodies 13A and 13B are locked with each other. Thus, it is no longer necessary to fabricate both a configuration at an inner surface of the movable portion and a configuration at an outer surface of the first body 13A with high accuracy.

Furthermore, the clip 100 in accordance with the first embodiment can stable pinch a target between the first and second parts 11 and 12 by virtue of a pushing force derived from an elastic restoring force caused by the movable portion 15.

In addition, since the projections 11f, 11g, 12f and 12g eat into a target, the target is not readily released from the clip 100, even if an external force acts on the target.

The clip 100 may be used in non-limited fields. For instance, the clip 100 may be preferably used in the cleaning industry to detachably pinch a first button and an associated button hole in a folded shirt having been cleaned.

### (Second Embodiment)

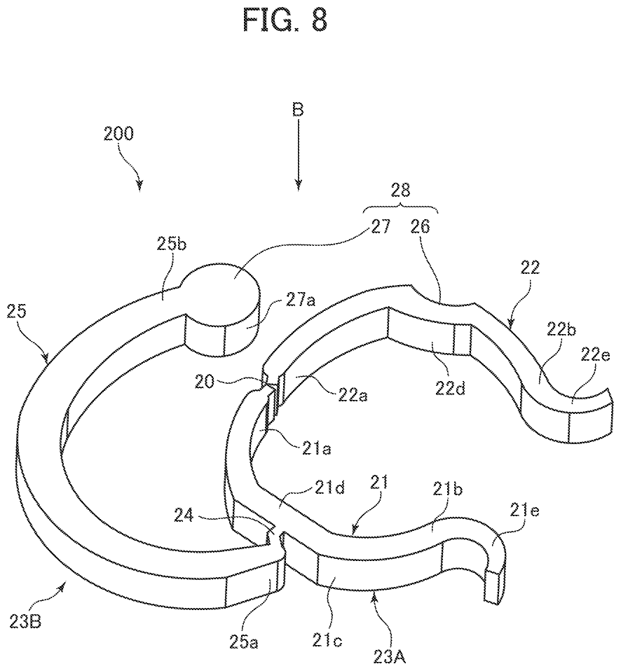

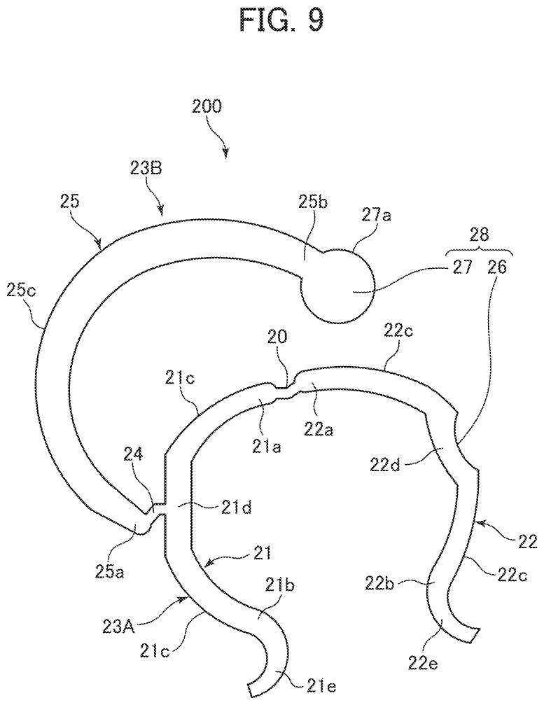

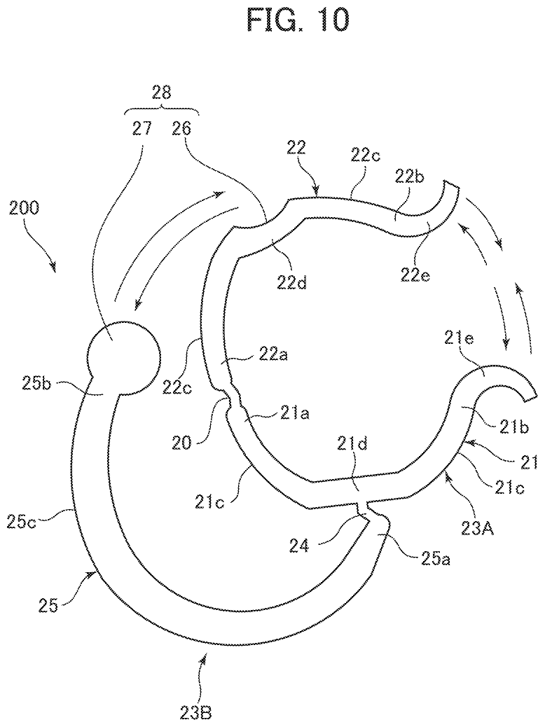

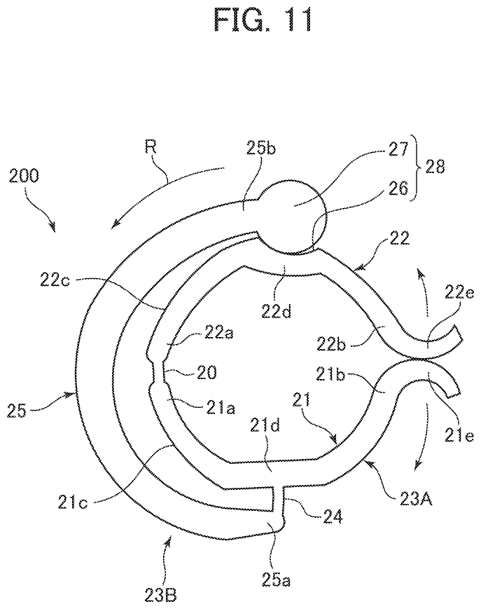

FIG. 8 is a perspective view of a clip 200 in accordance with the second embodiment, and FIGS. 9 to 11 are plan views of the clip 200.

Parts or elements that correspond to those of the clip 100 in accordance with the first embodiment are provided with a reference numeral equal to the reference numeral of the first embodiment to which 10 is added. For instance, whereas the movable portion in the first embodiment is provided with the reference number 15, the movable portion in the second embodiment is provided with the reference number 25.

The clip 200 in accordance with the second embodiment is structurally identical with the clip 100 in accordance with the first embodiment except the following differences.

In comparison with the clip 100 in accordance with the first embodiment, the first part 21 of the first body 23A is designed not to include the projections 11f, 11g and the extension 19, and the second part 22 is designed not to include the projections 12f and 12g. The movable portion 25 of the second body 23B is designed not to include the finger-contact portion 15b.

It should be noted that the clip 200 in accordance with the second embodiment may be designed to include the projections 11f and 11g, the projections 12f and 12g, the extension 19, and finger-contact portion 15b.

In the clip 200 in accordance with the second embodiment, the second hinge 24 and the recess 26 are designed to be situated at the almost same distance from the first hinge 20.

Furthermore, the first part 21 is designed at the other end 21b to be curved towards the second part 22 to thereby define a guide 21e, and the second part 22 is designed at the other end 22b to be curved towards the first part 21 to thereby define a guide 22e.

How to use the clip 200 is identical with how to use the clip 100 except the followings.

In using the clip 200, a user puts his/her thumb onto the clip 200 in the vicinity of the distal end 25a of the movable portion 25 and the second hinge 24, and further, puts his/her index finger onto the clip 200 in the vicinity of the distal end 25b of the movable portion 25 at an outer surface 25c to thereby hold the clip 200 at entirety.

After a target (not illustrated) is pinched between the first and second parts 21 and 22, the user applies a force to his/her thumb and index finger to thereby cause the engagement portion 27 to move towards the recess 26. Then, the engagement portion 27 makes contact with the arcuate outer surface 22c of the second part 22 in the vicinity of the end 22a of the second part 22, and then, slides on the outer surface 22c towards the recess 26. Thereafter, the engagement portion 27 is fit into the recess 26.

The action for releasing a target out of the clip 200 is identical with the action to be carried out for doing the same in the clip 100.

The clip 200 in accordance with the second embodiment provides the same advantages as those provided by the clip 100 in accordance with the first embodiment.

In addition to those advantages, since the first and second parts 21 and 22 in the clip 200 are designed to include at the ends 21b and 22b the guides 21e and 22e inwardly curving towards each other, a target (not illustrated) can be readily pinched between the first and second parts 21 and 22.

Hereinbelow are explained the advantages provided by the clip 200 in accordance with the second embodiment over the clip disclosed in U.S. Pat. No. 7,360,286 B2 to Shimizu.

Hereinbelow the reference numerals used in U.S. Pat. No. 7,360,286 are used as they are.

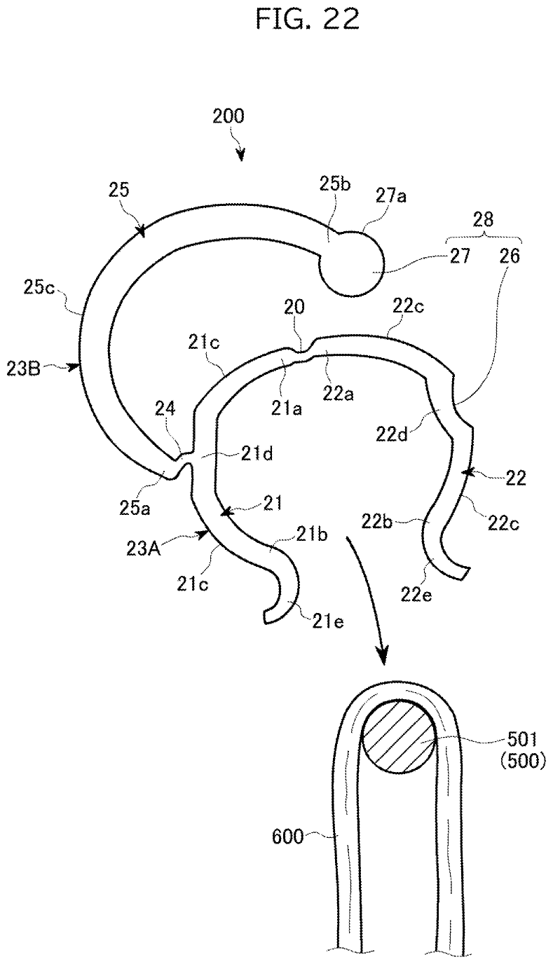

(A) As illustrated in FIG. 22, the clip 200 can pinch a cloth 600 put around a horizontal bar 501 of a hanger 500 together with the horizontal bar 501 from thereabove.

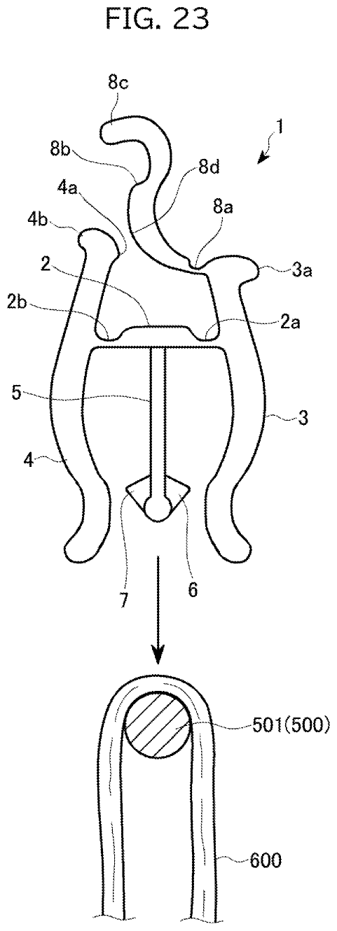

In contrast, as illustrated in FIG. 23, the 286 clip cannot pinch the cloth 600 from above together with the horizontal bar 501 due to the vertical piece 5.

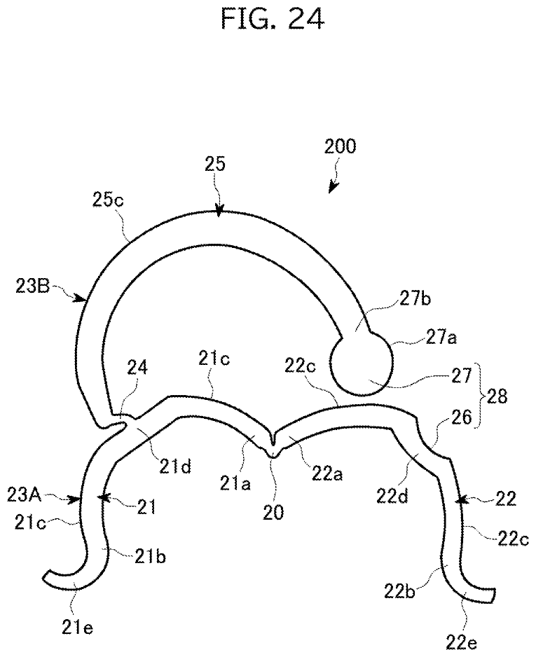

(B) As illustrated in FIG. 24, the movable portion 25 moves towards the first part 21 around the second hinge 24 when the first and second parts 21 and 22 are spaced away from each other. Thus, the outer surface 22c of the second part 21 does not interfere with the recess 26, and accordingly, the first and second parts 21 and 22 can be widely spaced away from each other. Consequently, the clip 200 can readily pinch a thick cloth 600 put on the horizontal bar 501.

In contrast, when the pinching pieces 3 and 4 are open away from each other in the 286 clip, the engaging protrusion 4a moves close to the lock piece 8. Thus, the pinching pieces 3 and 4 cannot be further open because the engaging protrusion 4a makes contact with the cam 8d, resulting in that it is not easy to pinch a thick cloth 600 with the 286 clip. The 286 clip can be used only in such a way as illustrated in FIG. 5 of 286.

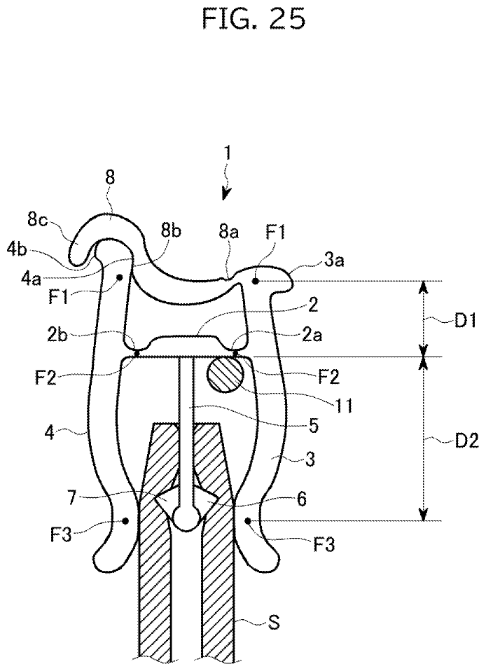

(C) As illustrated in FIG. 25, while a skirt S is pinched by the 286 clip, points located in the vicinity of the thin-walled portion 8a and the depressed portion 8b work as power points F1, points located in the vicinity of the thin-walled portions 2a and 2b work as fulcrums F2, and the arcuate portions located at lower ends of the pinching pieces 3 and 4 work as points of action F3.

Since a distance D1 between the power points F1 and the fulcrums F2 is smaller than a distance D2 between the fulcrums F2 and the points of action F3 (D1<D2), a pinching force provided to the skirt S by the pinching pieces 3 and 4 is smaller than a force provided by the lock piece 8 to a portion extending between the tab 3a and the engaging protrusion 4a. It is guessed in view of FIG. 25 that the pinching force is about 40% of the latter mentioned force.

Furthermore, the pinching force provided by the pinching pieces 3 and 4 decreases at a point closer to the lower ends of the pinching pieces 34 from the thin-walled portions 2a and 2b, and is minimized at the arcuate portions located at the lower ends of the pinching pieces 3 and 4, that is, the points of action F3, though a maximum pinching force is required there. Accordingly, it is obvious that the 286 clip lacks a pinching force.

A pinching force can be increased by lengthening the distance D1. Portions of the pinching pieces 2 and 4 situated above the fulcrums F2 are necessary to have an increased length in order to lengthen the distance D1. However, if so, as mentioned above in the paragraph (B), the pinching pieces 3 and 4 cannot be widely open from each other. Thus, there is a limit in lengthening the distance D1.

Thus, the 286 clip cannot provide a sufficient pinching force relative to a length of the pinching pieces 3 and 4. Thus, in order to compensate for the insufficient pinching force by the pinching pieces 3 and 4, the 286 clip is designed to include the vertical piece 5 on which the protrusions 6 and 7 are formed.

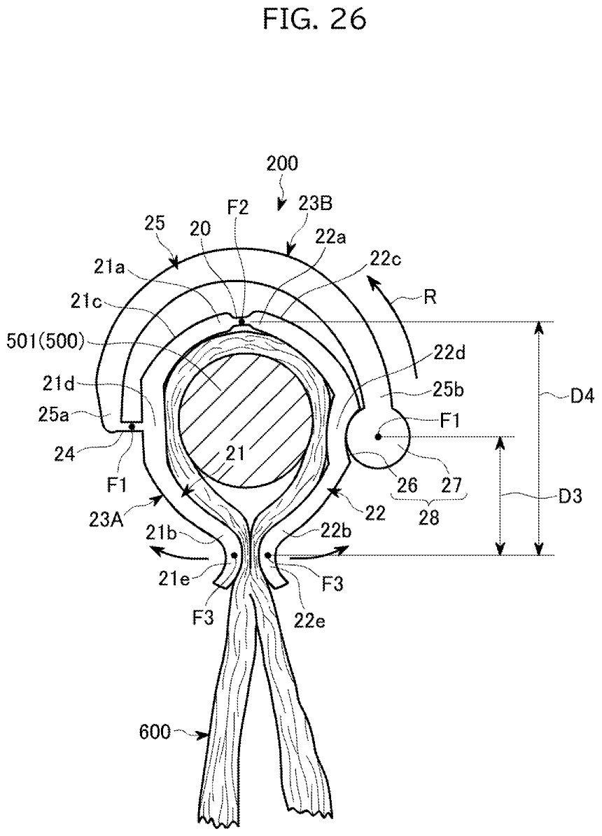

In contrast, as illustrated in FIG. 26, the power points F1 (the second hinge 24 and the arcuate portion 27) are designed to be located between the fulcrum F2 (the first hinge 20) and the points of action F3 (the guides 21e and 22e) in the clip 200. This ensures that a pinching force is provided equally to entirety of the first and second parts 21 and 22.

Furthermore, a maximum pinching force is generated at portions close to the power points F1. Accordingly, the clip 200 can firmly pinch the cloth 600 together with the horizontal bar 501 when the cloth 600 put on the horizontal bar 501 is pinched by the first and second parts 21 and 22.

Furthermore, since the power points F1 are located between the fulcrum F2 and the points of action F3 in the clip 200, it is possible to prevent the clip 200 from being upsized, even if a distance D3 between the power points F1 and the points of action F3 for enhancing a pinching force.

Thus, the clip 200 can provide a sufficient pinching force, even if the first and second parts 21 and 22 are short in length.

The structure illustrated in FIG. 7 can be applied to the clip 200.

### (Third Embodiment)

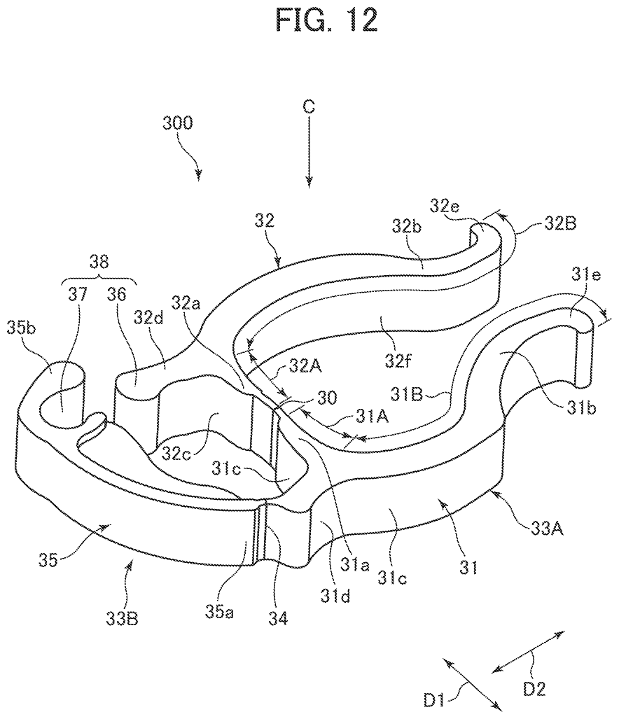

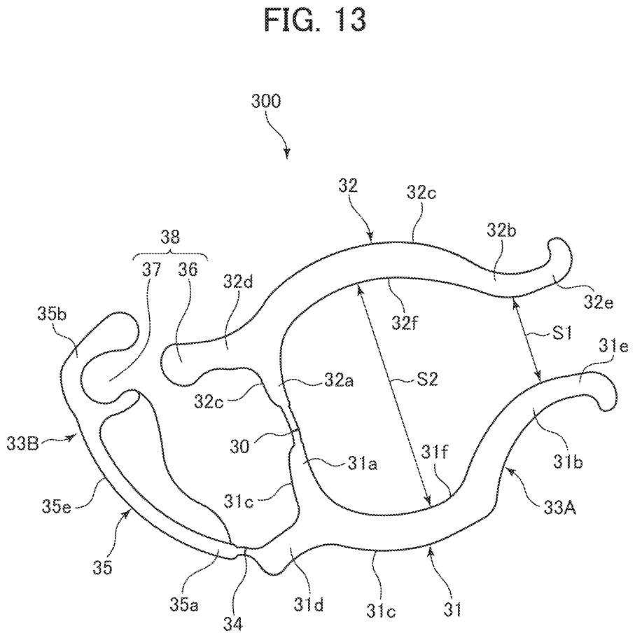

FIG. 12 is a perspective view of a clip 300 in accordance with the third embodiment, and FIGS. 13 to 15 are plan views of the clip 300.

Parts or elements that correspond to those of the clip 100 in accordance with the first embodiment are provided with a reference numeral equal to the reference numeral of the first embodiment to which 20 is added.

Comparing the clip 300 to the clip 200, the lock 38 is structurally distinguishable from the lock 28 of the second embodiment.

In the clips 100 and 200 in accordance with the first and second embodiments, the first bodies 13A and 23A are formed with the recess 16 and 26, and the second bodies 13B and 23B are formed with the projections 13B and 23B. In contrast, in the clip 300 in accordance with the third embodiment, the first body 33A is formed with a projection, and the second body 33B is formed with a recess.

Specifically, as illustrated in FIG. 12, the lock 38 in the third embodiment is comprised of a projection 36 outwardly extending from an outer surface 32c of the second part 32 in the first body 33A, and a recess 37 formed at the other end 35b of the movable portion 35 in the second body 33B. The projection 36 can be fit into the recess 37.

In the clip 300 in accordance with the third embodiment, the first part 31 includes a first portion 31A extending in a first direction D1, and a second portion 31B extending in a second direction D2 almost perpendicular to the first direction D1, and the second part 32 includes a first portion 32A extending in the first direction D1, and a second portion 32B extending in the second direction D2. The first and second parts 31 and 32 are joined to each other at the first portions 31A and 32A thereof through the first hinge 30.

The projection 36 is designed to extend in the second direction D2 from the first portion 32A of the second part 32.

Furthermore, a second projection 31d having a shape almost identical with the same of the projection 36 extends in the second direction D2 from the first portion 31A of the first part 31. The movable portion 35 in the form of an almost L-shape is joined to the distal end of the second projection 31d through the second hinge 34.

The projection 36 and the second projection 31d are situated at an equal distance from the first hinge 30.

Furthermore, as illustrated in FIG. 13, when the clip 300 in an open condition, a minimum gap 51 between the guides 31e and 32e is designed to be about ⅓ to about ½ relative to a maximum gap S2 between an inners surface 31f of the first part 31 and an inner surface 32f of the second part 32.

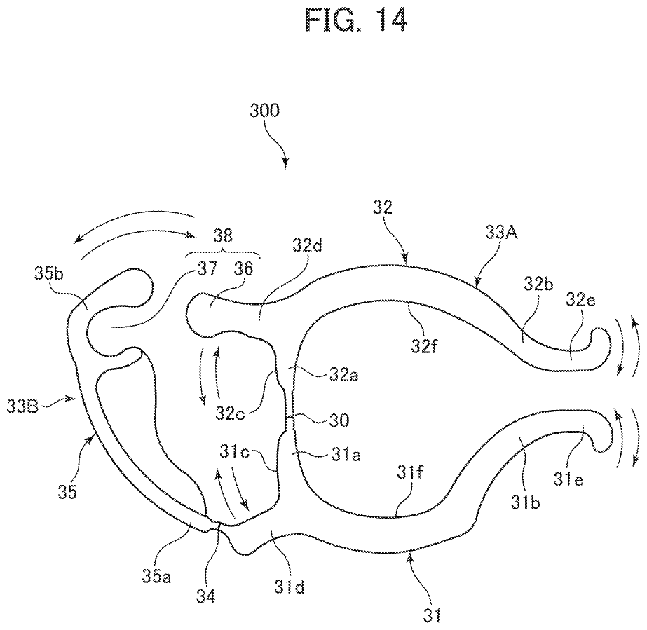

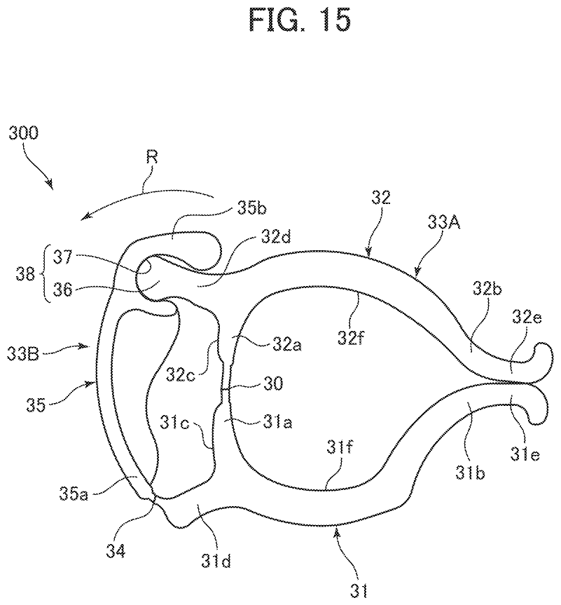

Hereinbelow is explained how to use the clip 300 with reference to FIGS. 14 and 15.

In using the clip 300, a user puts his/her thumb onto the second projection 31d, and his/her index finger onto the projection 36 to thereby hold the clip 300 at entirety.

Then, a user moves his/her thumb and index finger to approach each other to thereby apply a pushing force to the clip 300. As a result, the first hinge 30 is elastically deformed such that the projection 36 and the second projection 31d move towards each other, and the minimum gap S1 between the guides 31e and 32e is increased.

Then, a user pushes an outer surface 35e of the movable portion 35 to thereby the recess 37 of the movable portion 35 to move towards the projection 36, and cause the projection 36 to be fit into the recess 36. FIG. 15 illustrates a condition in which the projection 36 is fit into the recess 37. As illustrated in FIG. 15, the projection 36 and the second projection 31d are put into such a condition that they are not able to physically move towards and away from each other while the projection 36 is being fit into the recess 37. Thus, the clip 300 can stably pinch a target between a distal end 31b of the first part 31 and a distal end 32b of the second part 32.

When a target is to be released out of the clip 300, a user puts his/her finger onto a distal end 35b of the movable portion 35, and applies a force to the movable portion 35 in a direction indicated with an arrow “R”, as illustrated in FIG. 15. The recess 37 is released from the projection 36, and the movable portion 35, the first part 31, and the second part 32 return to the condition illustrated in FIG. 14 by virtue of an elastic restoring force thereof. Then, a user pushes the projection 36 and the second projection 31d so as to cause them to move towards each other, resulting in that the minimum gap S1 between the guides 31e and 32e is broadened, and thus, a target can be released out of the clip 300.

The clip 300 in accordance with the third embodiment provides the same advantages as those provided by the clip 100 in accordance with the first embodiment.

In particular, in the conventional clip, it was necessary to lift up the recess 122 beyond the projection 116 in order to cause the projection 116 to be fit into the recess 122 or to release the recess 122 from the projection 116.

In contrast, in the clip 300 in accordance with the third embodiment, since the recess 37 lowers down to the projection 36 or rotates downwardly to the projection 36 in a direction opposite to the direction “R” when the projection 36 is fit into the recess 37, it is no longer necessary to lift up the projection 36. Similarly, when the recess 37 is to be released from the projection 36, it is possible to release the recess 37 from the projection 36 merely by upwardly rotating the recess 37 relative to the projection 36.

Furthermore, the minimum gap 51 between the guides 31e and 32e is designed to be about ⅓ to about ½ relative to the maximum gap S2 between the inners surface 31f of the first part 31 and the inner surface 32f of the second part 32 when the clip 300 in an open condition, and accordingly, a target can be temporally pinched between the first and second parts 31 and 32 by virtue of the elastic restoring force caused by the first hinge 30.

### (Fourth Embodiment)

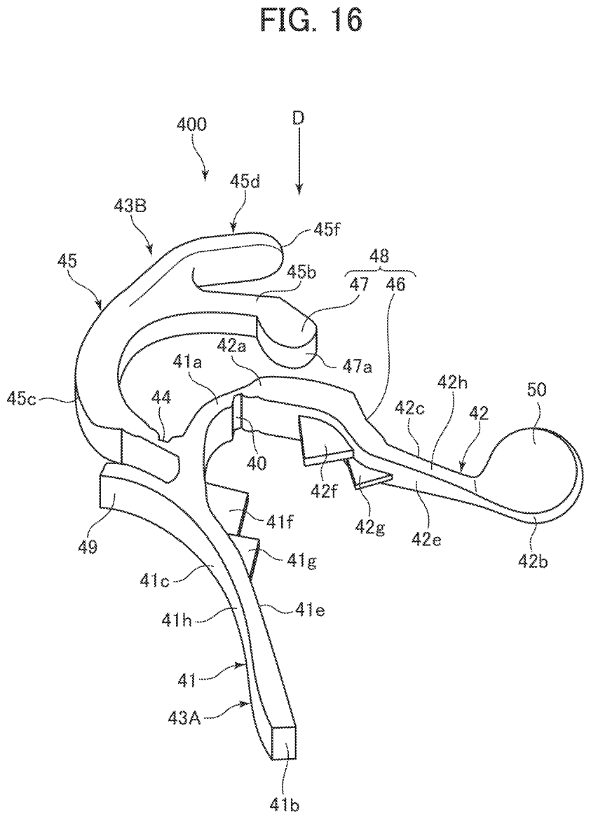

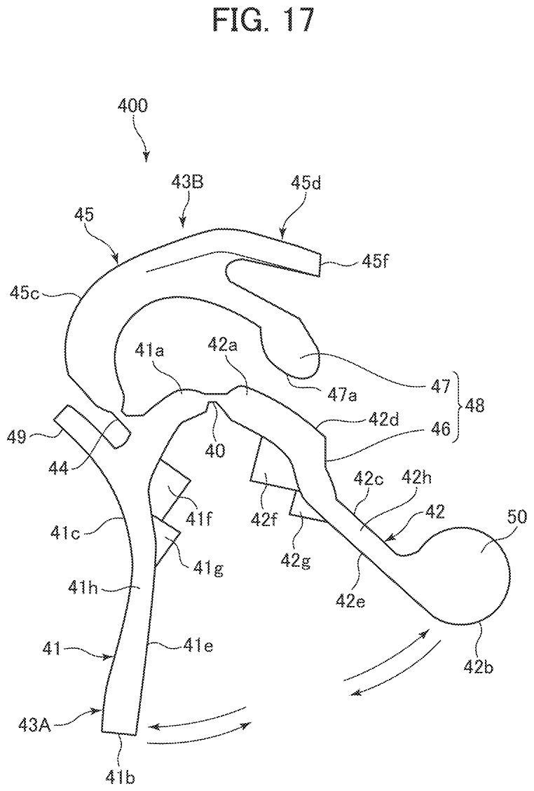

FIG. 16 is a perspective view of a clip 400 in accordance with the fourth embodiment, and FIGS. 17 to 19 are plan views of the clip 400.

Parts or elements that correspond to those of the clip 100 in accordance with the first embodiment are provided with a reference numeral equal to the reference numeral of the first embodiment to which 30 is added.

The clip 400 in accordance with the fourth embodiment is structurally different from the clip 100 in accordance with the first embodiment in the followings. It should be noted that elements of the clip 400 may be different in shape, but are not different in function from the corresponding elements of the clip 100.

The clip 400 includes a circular portion 50 formed at an end 42b of the second part 42 and outwardly extending from an outer surface 42c of the second part 42.

Furthermore, the clip 400 includes projections 41f, 41g, 42f and 42g in place of the projections 11f, 11g, 12f and 12g.

Specifically, two triangular projections 41f and 41g project on an inner surface 41e of the first part 41 towards the second par 42, and two triangular projections 42f and 42g project on an inner surface 42e of the second part 42 towards the first par 41.

The projections 41f and 42f are situated closer to ends 41a and 42a than ends 41b and 42b of the first and second parts 41 and 42, and the projections 41g and 42g are situated closer to the ends 41b and 42b than the ends 41a and 42a of the first and second parts 41 and 42. The projections 41f and 41g are located adjacent to each other in a length-wise direction of the first part 41 and are spaced away in a thickness-wise direction of the first part 41. Similarly, the projections 42f and 42g are located adjacent to each other in a length-wise direction of the second part 42 and are spaced away in a thickness-wise direction of the second part 42.

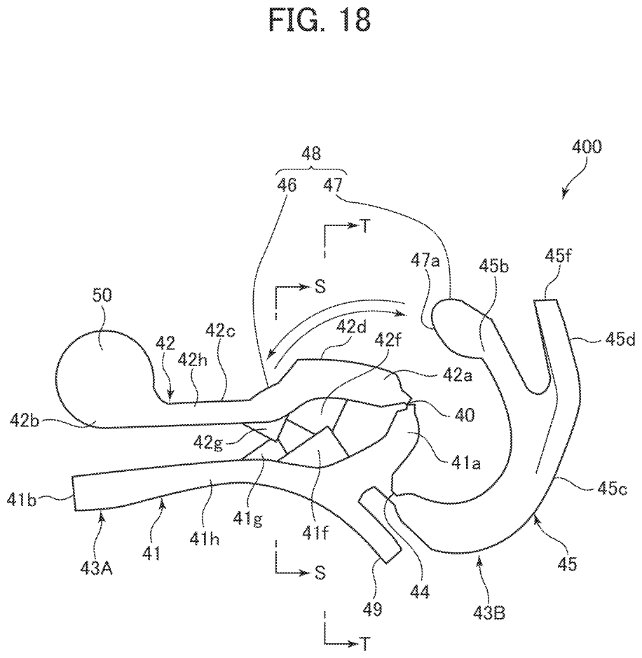

Accordingly, as illustrated in later-mentioned FIGS. 18 to 21, the projections 41f and 42f partially overlap each other and make contact with each other, and further, the projections 41g and 42g partially overlap each other and make contact with each other, when the first and second parts 41 and 42 are located close to each other.

The first part 41 includes a weak portion 41h having a thickness smaller than the same of other portions, and accordingly, having a modulus of bending elasticity smaller than the same of the other portions in the vicinity of a center in a length-wise direction of the first part 41, specifically, at a location closer to the end 41b than the projection 41g. Similarly, the second part 42 includes a weak portion 42h having a thickness smaller than the same of other portions, and accordingly, having a modulus of bending elasticity smaller than the same of the other portions in the vicinity of a center in a length-wise direction of the second part 42, specifically, at a location closer to the end 42b than the projection 42g. Thus, when the clip 400 pinches a thick target between the ends 41b and 42b, the weak portions 41h and 42h are first elastically deformed.

How to use the clip 400 is identical with how to use the clip 100.

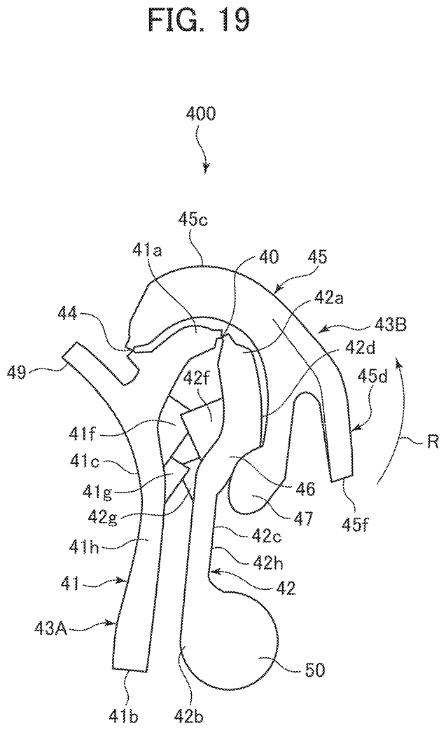

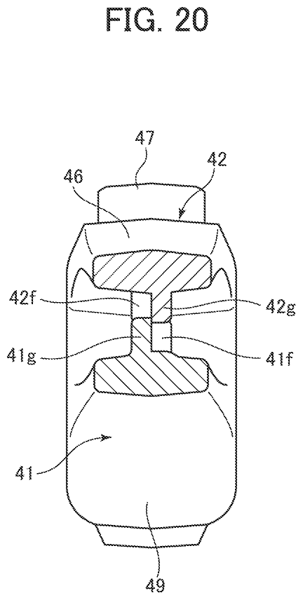

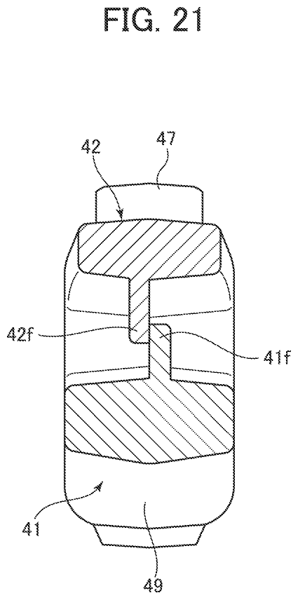

When the clip 400 is in a closed condition (a condition illustrated in FIG. 19), that is, when the first and second parts 41 and 42 are located close to each other, the projections 41g and 42g partially overlap and make contact with each other at top sharpened portions, as illustrated in FIG. 20, and the projections 41f and 42f partially overlap and make contact with each other at top sharpened portions, as illustrated in FIG. 21.

Thus, since the projections 41f, 42f, 41g and 42g eat into a target (not illustrated) pinched between the first and second parts 41 and 42, the target can be firmly held, and is not readily released from the clip 400, even if an external force applies onto the target.

For instance, in the case that a first button and an associated button hole of a shirt are pinched by the clip 400, it is possible to prevent the first and second parts 41 and 42 from deviation of each other, even if a force applies to the first button and the button hole to draw them in opposite directions, since the projections 41f and 42f overlap each other, and further, the projections 41g and 42g overlap each other.

As mentioned before, the first and second parts 41 and 42 are designed to include the weak portions 41h and 42h in the vicinity of centers in length-wise directions of the first and second parts 41 and 42, respectively. Consequently, in the case that a thick target is pinched between the ends 41b and 42b, the weak portions 41h and 42h are elastically deformed, and hence, it is possible to prevent the lock from not readily establishing, ensuring that a target is stably pinched.

The clip 400 in accordance with the fourth embodiment provides the same advantages as those provided by the clip 100 in accordance with the first embodiment.

### INDUSTRIAL APPLICABILITY

The clip in accordance with the present invention can be broadly utilized in various industrial fields in which various targets are necessary to be detachably pinched.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed is:

1. A clip including a first body and a second body, the first body and the second body being integrally made of an elastic material,
the first body including
a first part,
a second part, and
a first hinge through which one of ends of the first part and one of ends of the second part are joined to each other such that the other end of the first part and the other end of the second part can move towards and away from each other,
guides being formed at the other end of the first part and the other end of the second part, respectively, the guides projecting more inwardly than the other ends,
the second body including
a movable portion having a shape crossing over the first and second parts around the first hinge, and
a second hinge,
the movable portion being joined at one of ends thereof to the first part through the second hinge so as to be swingable in a plane defined by the first and second parts,
a part of the first body and a part of the second body defining a lock for detachably locking the other end of the movable portion to the second part,
the lock including
an arcuate portion formed at the other end of the movable portion, and
a recess formed at an outer surface of the second part, the arcuate portion being fittable into the recess,
wherein the first hinge works as a fulcrum, the guides work as points of action, and both the second hinge and the arcuate portion work as power points while the clip is pinching an object, the power points being located between the fulcrum and the points of action.

2. The clip as set forth in claim 1, wherein the movable portion is C-shaped.

3. The clip as set forth in claim 1, wherein the second part includes a flat guiding surface at an outer surface, the flat guiding surface leading to the recess, the flat guiding surface inclining relative to a length-wise direction of the second part, the arcuate portion sliding on the flat guiding surface, and then, being fit into the recess.

4. The clip as set forth in claim 3, wherein the arcuate portion defines a part of a circle, and
a center of the circle is situated closer to an outer surface of the second part than an extension of the flat guiding surface when the arcuate portion is fit into the recess.

5. The clip as set forth in claim 1, wherein the first part includes an extension outwardly extending from an outer surface of the first part between the other end of the first part and the second hinge.

6. The clip as set forth in claim 1, wherein the first and second parts include at least one projection projecting from an inner surface of the first and second parts towards the second and first part,
the projections of the first and second parts partially making contact with each other or partially overlapping each other when the other ends of the first and second parts move towards each other.
